(19) United States
(12) Patent Application Publication
(10) Pub. No.: US 2002/0071052 A1
(43) Pub. Date: Jun. 13, 2002

(54) Transmission rate control method

(76) Inventors: Tomoaki Itoh, Osaka (JP); Takao Yamaguchi, Kyoto (JP); Junichi Sato, Nara (JP); Hiroshi Arakawa, Kyoto (JP); Yoji Notoya, Osaka (JP)

Correspondence Address: HARNESS, DICKEY & PIERCE, P.L.C., P.O. BOX 828, BLOOMFIELD HILLS, MI, 48303, US

(21) Appl. No.: 10/006,313

(22) Filed: Dec. 5, 2001

(30) Foreign Application Priority Data
Dec. 7, 2000 (JP) 2000-372629
Jan. 22, 2001 (JP) 2001-012779

(51) Int. Cl. H04N 7/12

(52) U.S. Cl. 348/384.1

(57) ABSTRACT

A video file including at least two sets of video data encoded from the viewpoints of encoding rate variation, motion priority and image quality priority is prepared on a sending terminal. Then, the video data to be sent are dynamically switched in accordance with motion/image priority instructions entered by a user into a receiving terminal, or changes in the available transmission bandwidth.

### BACKGROUND OF THE INVENTION

The present invention relates to a transmission rate control method that can adapt to changes in the available transmission bandwidth, transmission errors and obstacles or the like.

When encoding video data at restricted encoding rates, there is a trade-off between “motion (frame rate)” and “image quality (quality per frame, which is decided by resolution and quantization steps”. When encoding at a high frame rate so as not to harm the fluency of the motion, that is, in the case of “motion priority”, because the information amount that is placed on one frame decreases, the image quality of each frame is reduced. Conversely, when encoding each frame at high image quality, that is, in the case of “image quality priority”, the information amount placed on one frame increases, so that the frame rate has to be reduced.

To solve this problem, in the video data recording device disclosed in JP 2000-287173A, the encoded video data are recorded by automatically setting suitable encoding parameters for the encoder, based on information regarding the content, for example information indicating whether it is a sports or a news program. Thus, it is possible to achieve encoding control for motion priority and image quality priority depending on the type of content.

On IP (Internet Protocol) networks such as intranets and internet, the available transmission bandwidth varies greatly with the connection form. And what is more, the available transmission bandwidth varies over time, due to the influence of other traffic. Here, “available transmission bandwidth” refers to the transmission bandwidth that can be used without causing congestion between the sending and the receiving terminals. In other words, it is the transmission bandwidth without the bandwidth used by the packets lost due to transmission errors or obstacles or the like. For example, when 10% of the packets are lost due to transmission errors at a transmission bandwidth of 100 kbps, then the available transmission bandwidth is 90 kbps.

In order to provide stable communication quality on such a network, a maximum value of the transmission bandwidth that can be guaranteed on the transmission path is estimated (this is also referred to as “bandwidth estimation”), and the data transmission rate from the sending terminal is adjusted depending on the temporal variation of the bandwidth (this is also referred to as “transmission rate control”).

Also with transmission rate control of video data in an environment in which certain transmission bandwidths are assigned, there is a trade-off between “motion” and “image quality”. It is a fact that in conventional streaming distribution of audio and video data (AV data), transmission rate control for motion priority and image quality in accordance with an instruction by the user (who consumes the content), or transmission rate control adapting to changes in the available transmission bandwidth was not possible. Consequently, if the available transmission bandwidth has become too narrow for the encoding rate of the video data to be sent, then packet loss occurs as not all video data can be sent.

### SUMMARY OF THE INVENTION

It is an object of the present invention to achieve, in a video distribution system, a transmission rate control for motion priority or image quality priority responding to user instructions, or a transmission rate control that adapts to changes in the available transmission bandwidth.

In accordance with the present invention, the transmission rate of data from a sending terminal is controlled by dynamically switching between at least two sets of video data encoded from at least one viewpoint of encoding rate variation, motion priority and image quality priority, in accordance with a change of an available transmission bandwidth or a user instruction.

As a more specific first example of a switching method, AV streams encoded at a plurality of encoding rates (namely 64 kbps, 56 kbps and 48 kbps) are prepared beforehand, the available transmission bandwidth is estimated, and the AV streams are switched depending on the estimation result.

As a second example, when a user instruction regarding motion priority or image quality priority is reported from the receiving terminal to the sending terminal (such an instruction can be reported in advance or it can be reported during the transmission of the AV stream), then, in the case of motion priority, the encoding rate of the AV stream to be transmitted is adjusted. For example, if the available transmission bandwidth is reduced, the encoding rate is changed from 64 kbps to 56 kbps. And when the available transmission bandwidth is reduced in the case of image quality priority, then the transmission rate is adjusted with the number of frames without changing the encoded AV stream.

As a third example, two types of AV streams, one with an encoding rate of 64 kbps encoded with motion priority and the other one encoded with image quality priority, are prepared. The AV stream to be transmitted by the sending terminal is determined depending on the user instructions from the receiving terminal.

### BRIEF DESCRIPTION OF THE DRAWINGS

FIG. 1 is a block diagram illustrating a configuration example of a video distribution system for realizing a transmission rate control method in accordance with the present invention.

FIG. 2 illustrates an example of a video file prepared in the video data storage portion in FIG. 1.

FIG. 3 is a sequence diagram illustrating the operation of the video distribution system in FIG. 1.

FIG. 4 shows an example of a specific format of the video file in FIG. 2.

FIG. 5 is a flowchart illustrating the operation of the video data selection portion in FIG. 1.

FIG. 6 is a flowchart illustrating in detail the step in FIG. 5 that decides the number of the video data to be sent.

FIG. 7 is a flowchart illustrating the operation of the video data read-in portion in FIG. 1.

### DETAILED DESCRIPTION OF THE INVENTION

The following is a detailed description of embodiments of the present invention, with reference to the accompanying drawings. Here, an example of applying the present invention to streaming distribution of storage content, as typified by VoD (Video on Demand) and IP broadcasting, is explained. It should be noted that in the embodiments of the present invention, “video data” refers to a plurality of video data sets encoding the same content from at least one viewpoint of encoding variation, motion priority and image quality priority. Furthermore, “video file” refers to files in which these plurality of video data sets have been grouped together as one.

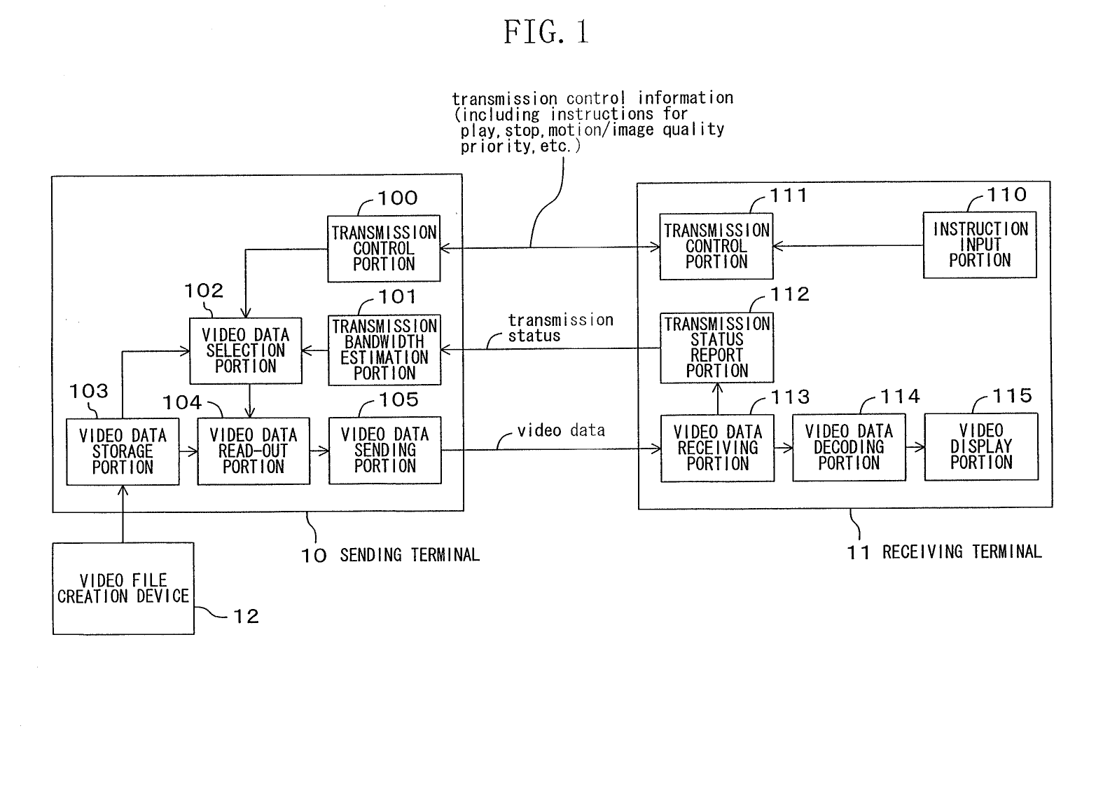

FIG. 1 illustrates a configuration example of a video distribution system for realizing a transmission rate control method in accordance with the present invention. In FIG. 1, numeral 10 denotes a sending terminal, numeral 11 denotes a receiving terminal, and numeral 12 denotes a video file creation device. The video file creation device 12 is a means for creating a video file including video data to be sent to the receiving terminal 11. The created video file is passed on to the sending terminal 10, and stored. It should be noted that in actuality, a plurality of receiving terminals are connected to the sending terminal 10, but in FIG. 1, only one receiving terminal 11 is shown, in order to simplify the explanations.

In the sending terminal 10, numeral 100 denotes a transmission control portion, numeral 101 denotes a transmission bandwidth estimation portion, numeral 102 denotes a video data selection portion, numeral 103 denotes a video data storage portion, numeral 104 denotes a video data read-out portion, and numeral 105 denotes a video data sending portion.

The transmission control portion 100 is a means for receiving from the receiving terminal 11 transmission control information including instructions regarding playing and stopping of video data as well as motion/image quality priority, and for reporting this information to the video data selection portion 102. It is assumed that with regard to the play/stop instructions, the protocol applied is a protocol for video transmission control, as typified by RTSP (Real Time Streaming Protocol) defined in RFC 2326, and methods such as Setup, Play and Describe can be utilized (see H. Schulzrinne et al., “Real Time Streaming Protocol”, RFC 2326, Internet Engineering Taskforce, April 1998). With regard to the motion/image quality priority instructions, it is possible to expand this protocol for video transmission control, or to use a special protocol for motion/image quality priority instructions. For example, it is possible to use expanded versions of the standard protocols P3P (Platform for Privacy Preferences) or CC/PP (Composite Capabilities/Preferences Profile), both standardized by the W3C (World Wide Web Consortium), as the special protocol for motion/image quality priority instructions.

The transmission bandwidth estimation portion 101 is a means for detecting congestion and transmission errors based on transmission status reports from intermediate nodes (such as routers) on the transmission path and from the receiving terminal 11, estimating the available transmission bandwidth, and reporting the estimation result as transmission rate instructions to the video data selection portion 102. The method for estimating the available transmission bandwidth can be chosen as appropriate, and suitable examples include the LDA (Loss-Delay Based Adjustment Algorithm) method (see D. Sisalem et al., “The Loss-Delay Based Adjustment Algorithm: A TCP-Friendly Adaptation Scheme”, in the proceedings of NOSSDAV′98, July, Cambridge, UK). With the LDA method, the data loss ratio is fed back from the receiving terminal 11 to the sending terminal 10, and the transmission rate of the sending terminal 10 is controlled based on the packet loss ratio and the receiving rate of the receiving terminal 11, for example.

The video data selection portion 102 is a means for selecting the video data to be sent in accordance with the available transmission bandwidth determined by the transmission bandwidth estimation portion 101 and the instructions from the transmission control portion 100 regarding motion/image quality priority, and reporting the selection result to the video data read-out portion 104. The video data selection portion 102 is also a means for starting and terminating the video data read-out portion 104 with the video data play/stop instruction from the transmission control portion 100.

The video data storage portion 103 is a means for storing video files including the video data to be sent to the receiving terminal 11, which can be a hard disk drive or a removable media device. This video file has been created beforehand by the video file creation device 12.

The video data read-out portion 104 is a means for reading out the video data selected by the video data selection portion 102 from the video data storage portion 103, and passing the read out video data on to the video data sending portion 105.

The video data sending portion 105 is a means for receiving the video data from the video data read-out portion 104, and sending it, if necessary in packets, to the receiving terminal 11. The protocol applied is assumed to be a protocol for sending data, as typified by RTP (Realtime Transport Protocol).

In the receiving terminal 11, numeral 110 denotes an instruction input portion, numeral 111 denotes a transmission control portion, numeral 112 denotes a transmission status report portion, numeral 113 denotes a video data receiving portion, numeral 114 denotes a video data decoding portion, and numeral 115 denotes a video display portion.

The instruction input portion 110 is an interface with which the user inputs video data play/stop instructions and motion/image quality priority instructions, and is a means for reporting the entered instructions to the transmission control portion 111.

The transmission control portion 111 is a means for sending transmission control information to the sending terminal 10, based on the report from the instruction input portion 110.

The transmission status report portion 112 is a means for calculating statistical information (such as packet loss ratio, propagation delay time or jitter) about the received video data, and for reporting the calculation results to the sending terminal 10 as a transmission status report. The protocol applied is assumed to be a protocol for sending statistical information, as typified by RTCP (RTP Control Protocol). It should be noted that if in the sending terminal 10 there is no need for the statistical information on the receiving terminal 11 for the bandwidth estimation with the transmission bandwidth estimation portion 101, then the transmission status report portion 112 is unnecessary.

The video data receiving portion 113 is a means for receiving video data from the sending terminal 10, and for passing them on, if necessary resolving packets, to the video data decoding portion 114.

The video data decoding portion 114 is a means for decoding the video data received from the video data receiving portion 113, and for passing the decoding result on to the video display portion 115.

The video display portion 115 is a means for displaying the data that have been decoded by the video data decoding portion 114 to the user, such as a liquid crystal display or the like.

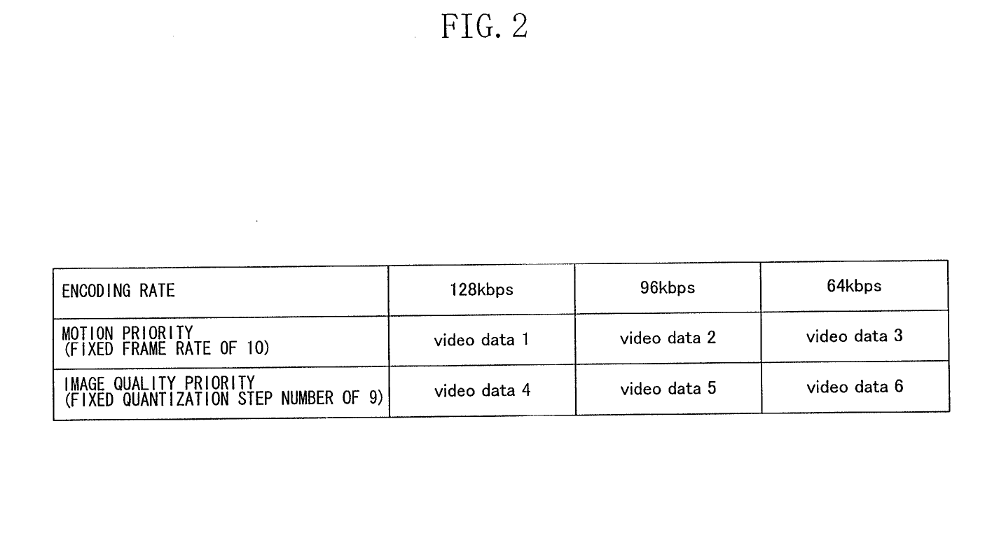

FIG. 2 illustrates an example of a video file created by the video file creation device 12 and prepared in the video data storage portion 103. The video file shown in FIG. 2 includes six sets of video data 1 to 6 that have been created based on the same content. These video data are encoded in three encoding rate variations (128 kbps, 96 kbps, 64 kbps) each from the viewpoint of motion priority (fixing the frame rate to “frame rate=10”) and from the viewpoint of image quality priority (fixing the quantization step at “quantization step=9”). In the video data 1, 2 and 3 encoded from the viewpoint of motion priority, the information amount to be sent decreases in that order. Also in the video data 4, 5 and 6 encoded from the viewpoint of image quality priority, the information amount to be sent decreases in that order. Needless to say, it is also possible to prepare more than two sets of video data in motion priority and image quality priority for each encoding rate.

Regarding the encoding parameter of the video data (for example, quantization step, image size, number of frames), the video data after switching are selected based on the encoding parameters for the video data before switching so that it is possible to prevent large changes in image quality. For example, the video data 4 to 6 for image quality priority in FIG. 2 are all encoded for “quantization step=9”, and their image size is the same. Consequently, when switching from the video data 4 with 128 kbps it is possible to prevent large changes in the image quality by selecting the video data 5 with 96 kbps or the video data 6 with 64 kbps as the video data after switching, and controlling the transmission rate with the number of frames per unit time.

It should be noted that in addition to or instead of the variation of the encoding rate in FIG. 2, it is also possible to prepare a plurality of video data sets with varying degrees of error robustness. For this, it is assumed that the video data are distributed over a wireless network such as a wireless LAN (Local Area Network), W-CDMA (Wideband Code Division Multiple Access) or FWA (Fixed Wireless Access). If the available transmission bandwidth is reduced due to transmission errors or obstacles on the wireless network, then it is possible to prevent the video images from deteriorating on the receiving terminal 11 by sending the video data having a higher degree of error robustness. An example of a supplemental method for error robustness is the supplementing of redundant data as shown in RFC 2733 (see J. Rosenberg et al., “An RTP Payload Format for Generic Forward Error Correction”, RFC 2733, Internet Engineering Taskforce, December 1999). Also, if MPEG (Moving Picture Coding Experts Group) 4 is used as the encoding scheme, then other examples include adding a HEC (Header Extension Code), shortening the period for AIR (Adaptive Intra Refresh), shortening the packet length, and shortening the insertion period for I-VOPs (Intra-Video Object Planes). When error robustness is imparted in this manner, then the frame rate or the image quality of the video data have to be reduced by an amount corresponding to the imparted error robustness. Consequently, also when the degree of error robustness is changed, it is necessary to decide in view of user instructions, content type, available transmission bandwidth etc., whether the priority is on motion or on image quality.

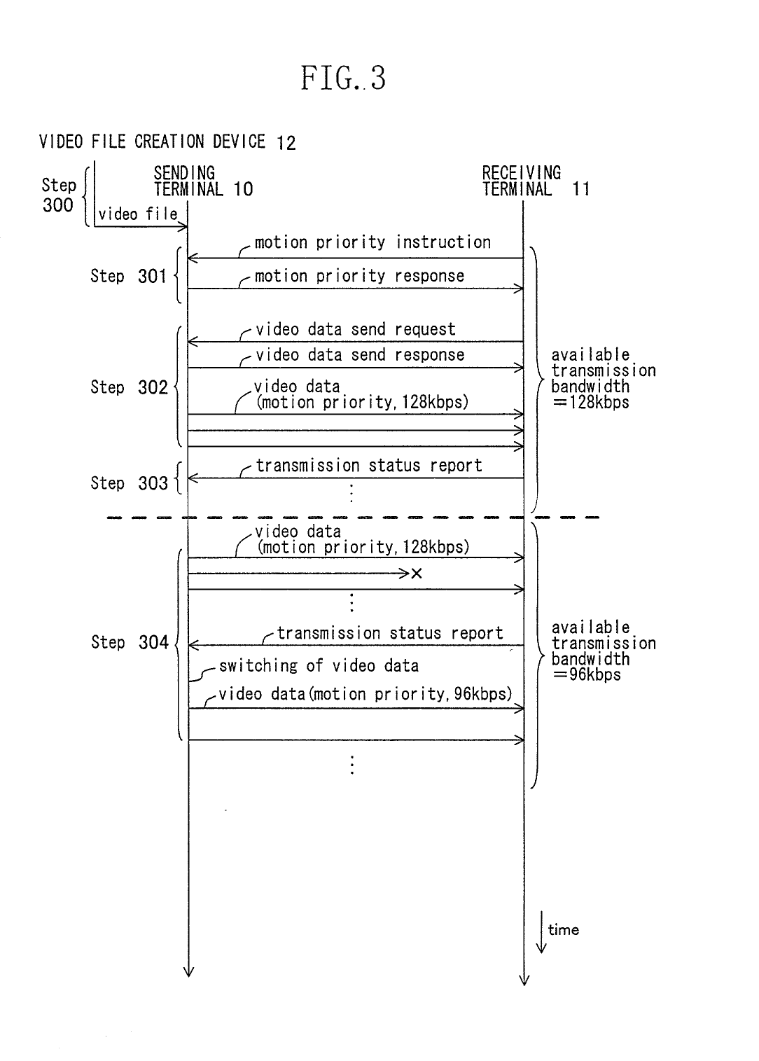

FIG. 3 is a sequence diagram illustrating the operation of the video distribution system in FIG. 1. First, in the video file creation device 12, the video file in FIG. 2 is created from certain content, and stored in the sending terminal 10 before the video transmission (Step 300). Then, before the video data are sent, the receiving terminal 11 sends motion/image quality priority instructions (Step 301). In the example in FIG. 3, the user has selected motion priority. Subsequently, the receiving terminal 11 sends a play instruction (video data send request) to the sending terminal 10, and the sending terminal 10 begins the sending of video data as instructed by the motion/image quality priority instruction (Step 302). In the example in FIG. 3, the image data 1 with motion priority and 128 kbps are sent. The receiving terminal 11 periodically issues a transmission status report and the sending terminal 10 estimates the available transmission bandwidth based on this report (Step 303). The bold dashed line in FIG. 3 indicates that the available transmission bandwidth has changed from 128 kbps to 96 kbps. When the sending terminal 10 detects that the available transmission bandwidth has become narrower in this manner, it switches the video data to be sent to the video data that are transmittable with the available transmission bandwidth, for example in FIG. 3 the video data 2 with motion priority and 96 kbps (Step 304). For this, the sending terminal 10 follows the user's motion/image quality instructions. It should be noted that in the example in FIG. 3, the motion/image quality instructions were performed before sending the video data, but it is also possible to send the motion/image quality instructions during the transmission of the video data.

Regarding the storage format of the video data, if a format is applied that combines the video data as separate access units, then the sending time has to be looked up searching in order from the beginning of the video data every time the sent video data are switched. This is because it is necessary to begin the sending of the video data after the switching starting with a continuation of the video data before the switching. This operation makes the smooth switching of files difficult. For example, when a switching of the video data occurs near the termination time of long-playing content, then the sending times of all data from the beginning of the video data up to the vicinity of the last video data are looked up, so that the processing time for the switching becomes long, and the video is halted for the time of this processing.

In accordance with the present invention, however, the switching of the video data due to a change in the available transmission bandwidth or due to user instructions is performed smoothly by recording two or more video data portions, from which one is to be sent (or received/reproduced) at a certain time, as one access unit in the video file.

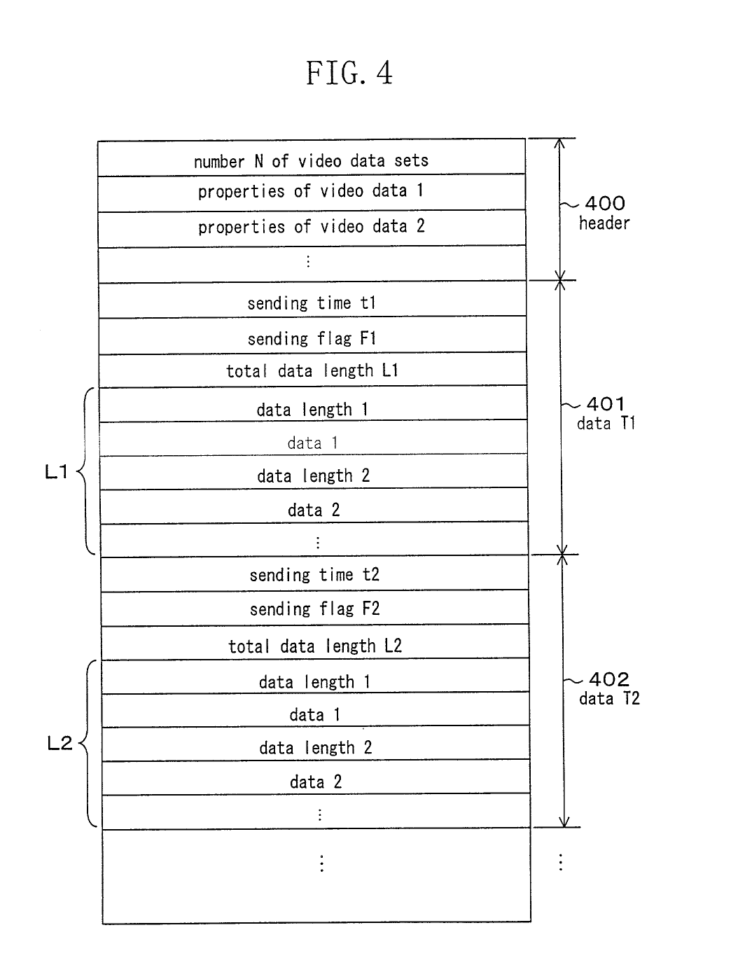

FIG. 4 shows an example of a specific format of the video file in FIG. 2. According to the format in FIG. 4, the video file is made up of a header 400, and regions 401 and 402 of data Tn (n=1, 2, . . . ) for each sending time.

The header 400 stores the number N (in the example in FIG. 2: N=6) of the video data sets stored in the video file. Then, it stores the properties of each of the video data sets. In this case, the properties include information indicating whether the video data have been encoded with motion priority or with image quality priority, and their encoding rates.

The region 401 of the data T1 stores first the sending time t1, the sending flag F1, and the total data length L1, in that order. The sending time t1 is the time at which one of the video data portions included in this region 401 should be sent. The sending flag F1 is a flag representing the numbers of the video data sets that should be sent at the sending time t1. For example, if N=6 and six sets of video data are stored in the video file, and if the partial data of one of the video data 1, video data 2 and video data 5 are sent at the time t1, then F1=“110010”. That is to say, the i-th bit (with i=1 . . . 6) from the beginning of the sending flag F1 indicates whether the video data i are sent at the time t1. If the value of the i-th bit is “1”, then they are data to be sent, and if it is “0”, then they are not data to be sent. The total data length L1 indicates the length of the remaining portion in region 401. Following this total data length L1, groups of data length of the video data j sent at the time t1 and the video data j are stored in order (for example, j=1, 2, 5). Here, the stored video data j are the video data for which the corresponding bit of the sending flag F1 is “1”. The file structure of the following region 402 of the data T2 and beyond is the same as that of the region 401.

Referring to the video file format shown in FIG. 4, the following is an explanation of how the video data selection portion 102 and the video data read-out portion 104 in FIG. 1 process the video data.

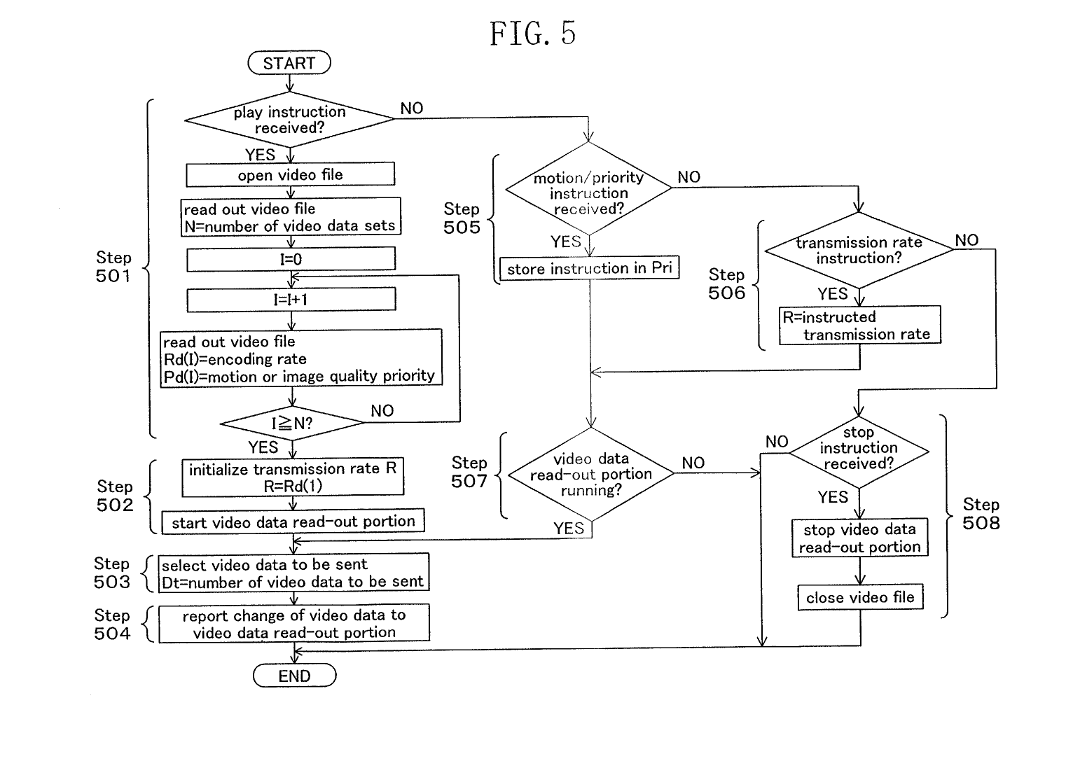

FIG. 5 illustrates the operation of the video data selection portion 102 in FIG. 1. The operation in FIG. 5 is performed when the video data selection portion 102 receives a report from the transmission control portion 100 or the transmission bandwidth estimation portion 101. If the received instruction is a play instruction, then the video file is opened, the number N of video data sets is read from this video file, and based on this number N, the information Pd(I) indicating whether the video data I are encoded with motion priority or with image quality priority, and the encoding rate Rd(I) of the video data I are read out and stored (Step 501). Next, the initial value of the transmission rate R is set as appropriate, and the video data read-out portion 104 is started (Step 502). For example, the encoding rate of the video data 1, that is Rd(1), is taken as the initial value of the transmission rate R. Then, the video data to be sent are selected (Step 503). Here, the number of the selected video data set is taken to be Dt. The selection method is explained below. Lastly, the change of the video data is reported to the video data read-out portion 104, and the operation is terminated (Step 504).

On the other hand, in the flowchart in FIG. 5, if the received instruction is a motion/image quality priority instruction, then this instruction is stored in Pri (Step 505). If a transmission rate instruction has been received from the transmission bandwidth estimation portion 101, the instructed transmission rate is stored in R (Step 506). After carrying out the processes of Step 505 and Step 506, it is determined whether the video data read-out portion 104 is running, and if it is running, the Steps 503 and 504 are carried out, whereas if it is not running, the operation is terminated (Step 507). If the received instruction is a stop instruction, then the video data read-out potion 104 is stopped, the video file is closed, and the operation is terminated (Step 508).

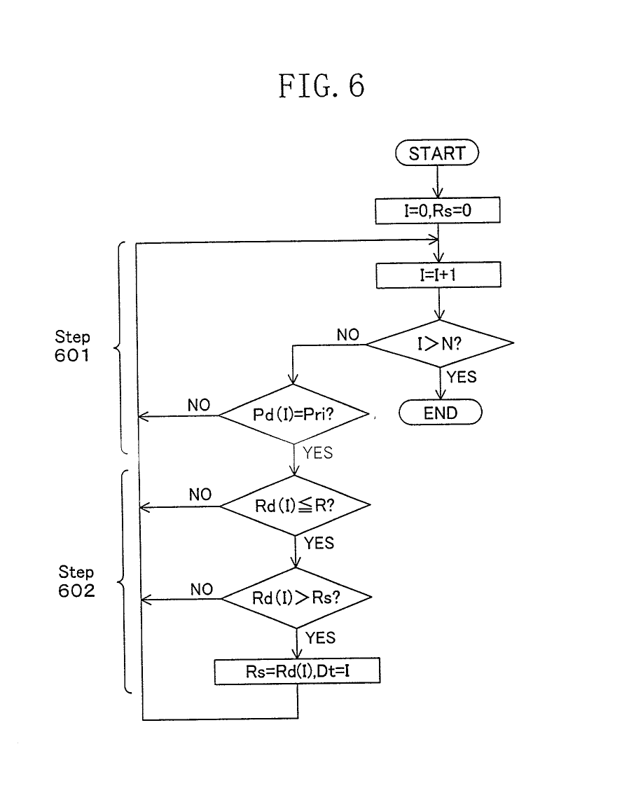

FIG. 6 illustrates Step 503 in FIG. 5, which decides the number of the video data set to be sent, in more detail. First, the reference encoding rate Rs is initialized to 0. Then it is determined whether the information Pd(I) of the video data I matches with the instruction Pri regarding motion/image quality priority, and if they do not match, then the procedure advances to the checking of the next video data, and if they do match, the procedure advances to the checking of the transmission rate (Step 601). If the encoding rate Rd(I) of the video data I is not higher than the instructed transmission rate R, and if it is higher than the encoding rate of video data checked in the past, in other words higher than the reference encoding rate Rs, then the number of the video data I is recorded as the number Dt of the video data to be sent, the reference encoding rate Rs is updated, and the procedure returns to Step 601 (Step 602). By performing this on all video data in the video file, video data having a maximum transmission rate in a range that is not larger than the instructed transmission rate R can be selected as the video data to be sent.

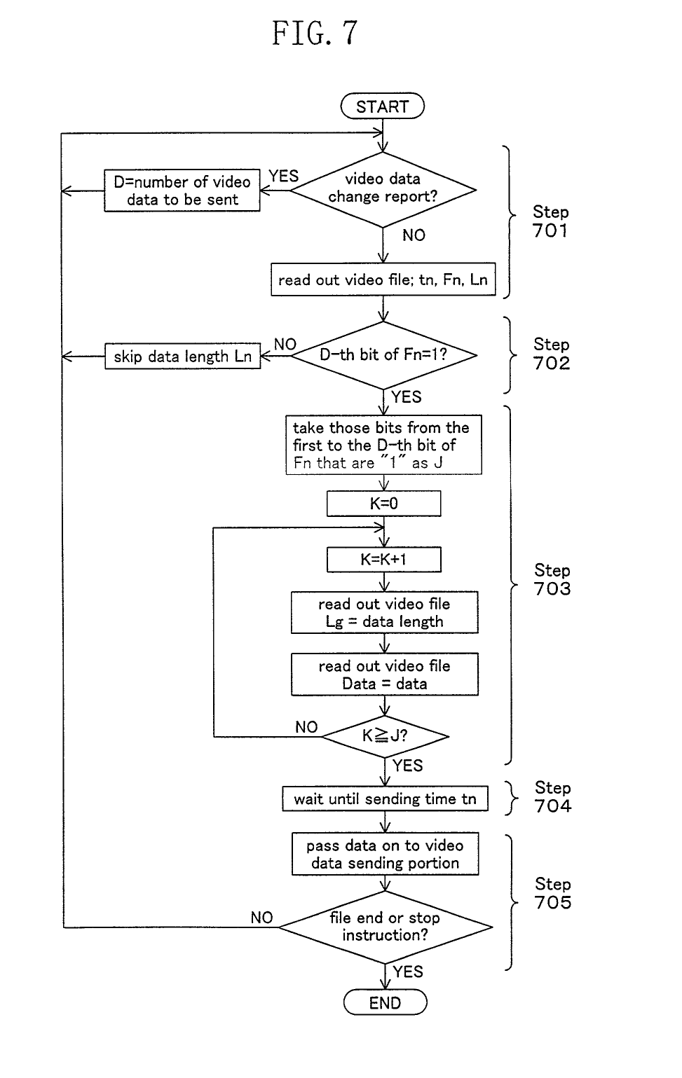

FIG. 7 illustrates the operation of the video data read-out portion 104 in FIG. 1. The video data read-out portion 104 reads out the necessary video data by reading in the continuation of the video file that has been opened by the video data selection portion 102 with the following steps. First, if the video data read-out portion 104 receives a video data change report from the video data selection portion 102, it stores the number D of the video data to be read out, and if it does not receive a video data change report, it reads in the sending time tn, the sending flag Fn and the total data length Ln from the video file (Step 701). Then, it is determined from the sending flag Fn whether the video data D should be sent at the time tn, and if there are no data to be sent, that is, if the D-th bit from the beginning of the sending flag Fn is “0”, then, based on the total data length Ln, the data up to the next sending time are skipped (Step 702). If there are data to be sent, then the data length Lg is read out, the step of skipping the data Data is repeated until reaching data to be sent, and the necessary video data are read out into Data (Step 703). Then, the procedure waits until the sending time tn (Step 704). At the sending time tn, the data Data are passed on to the video data sending portion 105, and when a stop instruction has been received or the end of the video file has been reached, the operation is terminated, and if that is not the case, then the procedure returns to Step 701 (Step 705).

As described above, by using the video file format of FIG. 4 it becomes unnecessary to perform the process of searching the video data portion corresponding to the next sending time starting with the beginning of the video file, when switching the video data to be sent.

It should be noted that in this embodiment of the present invention, as illustrated in FIG. 2, two types of video data, namely with motion priority and with image quality priority, are prepared for each encoding rate, but it is also possible to prepare only one type of video data for the various encoding rates. For example, it is possible to prepare only the video data 1 to 3 for motion priority in FIG. 2 as the video file. Then, when the available transmission bandwidth is reduced or increased in the case of motion priority, the video data to be sent are switched. And when the available transmission bandwidth is reduced or increased in the case of image quality priority, then the transmission rate is adjusted by culling the frames of the video data without switching the video data to be sent.

Furthermore, it is also possible to determine the motion/image quality priority not based on the user's instructions but to prepare the video data encoded with either motion or image quality priority based on the type of content. For example, if the content is a sports program, then only video data with motion priority, and if the content is a news program or a movie then only video data with image quality priority are prepared, and the video data to be sent are switched depending on the change of the available transmission bandwidth. Thus, when the available transmission bandwidth becomes narrow, it is possible to switch between motion and image quality priority depending on the type of content.

The present invention can be applied not only to unicast but also to multicast video distribution systems, on wired networks or on wireless networks. Furthermore, the present invention can be applied not only to video distribution systems using narrow-band transmission paths, but also to those using broad-band transmission paths. Also in the case of broad-band, it can be expected that the sent content is accordingly of high quality, and the information amount to be sent is large, so that also in this case transmission rate control will be necessary.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

What is claimed is:

1. A transmission rate control method controlling a transmission rate by dynamically switching between at least two sets of video data encoded from at least one viewpoint of encoding rate variation, motion priority and image quality priority, in accordance with a change of an available transmission bandwidth or a user instruction.

2. The transmission rate control method according to claim 1,
comprising a step of preparing a video file including said at least two sets of video data, created beforehand based on the same content.

3. The transmission rate control method according to claim 2,
wherein said preparation step comprises a step of recording at least two video data portions, one of which is to be sent at a certain time, as one access unit into the video file.

4. The transmission rate control method according to claim 2,
wherein said preparation step comprises a step of recording a plurality of video data sets having different degrees of error robustness in the video file.

5. The transmission rate control method according to claim 1, comprising the steps of:
estimating available transmission bandwidth;
selecting one of said at least two sets of video data in accordance with the available transmission bandwidth; and
sending the selected video data.

6. The transmission rate control method according to claim 1, comprising the steps of:
receiving a motion/image quality priority instruction from a user;
selecting one of said at least two sets of video data in accordance with the motion/image quality priority instruction; and
sending the selected video data.

7. The transmission rate control method according to claim 1, comprising a step of selecting video data after switching based on encoding parameters of the video data before switching.
